(19) United States
(12) Patent Application Publication
(10) Pub. No.: US 2026/0116576 A1
(43) Pub. Date: Apr. 30, 2026

(54) BREAKAWAY PORT FOR THERMAL CONDITIONING SYSTEM FOR ELECTRIC AIRCRAFT

(71) Applicant: BETA AIR LLC, South Burlington, VT (US)

(72) Inventors: Jeffrey M. Goldman, Williston, VT (US); Edward R. Hall, Starksboro, VT (US); Sarah Overfield, Colchester, VT (US); Jake Pill, Burlington, VT (US)

(21) Appl. No.: 19/044,779

(22) Filed: Feb. 4, 2025

Related U.S. Application Data
(60) Provisional application No. 63/549,776, filed on Feb. 5, 2024.

(51) Int. Cl. B64F 1/36; B60L 58/26

(52) U.S. Cl. CPC B64F 1/36; B60L 58/26; B60L 2200/10

(57) ABSTRACT

A breakaway port for a thermal conditioning system for an electric aircraft is disclosed. The breakaway port includes a mounting member including at least one port for a thermal conditioning liquid. The at least one port fluidly communicates with a liquid-based thermal conditioning circuit in the electric aircraft. A breakaway member is coupled to the mounting member. The at least one fitting liquidly couples to at least one of a liquid inlet conduit and a liquid outlet conduit. A sealing member may be between the mounting member and the breakaway member to seal between the at least one port and the at least one fitting. Breakaway retainer(s) couple the breakaway member to the mounting member and separate to decouple the breakaway member from the mounting member in response to a predetermined force being applied to the breakaway retainer(s).

### PRIORITY CLAIM

This application claims priority to U.S. Provisional Patent Application No. 63/549,776 (filed Feb. 5, 2024), the entire contents of which are hereby incorporated by reference.

### TECHNICAL FIELD

The disclosure relates generally to risk reduction mechanisms for electric aircraft. More specifically, the disclosure relates to a breakaway port for a thermal conditioning system for an electric aircraft.

### BACKGROUND

Electric aircraft include an energy source, typically a battery, which powers a propulsor of the aircraft. The energy source may be thermally conditioned, e.g., cooled or heated, by coupling a thermal conditioning circuit within the electric aircraft to a liquid-based thermal conditioning system. The liquid-based thermal conditioning media is provided by a ground-based system that couples to the electric aircraft through a handle and a pair of conduits and conveys a thermal conditioning liquid to the fluid circuit in the electric aircraft. Accidental damage can occur to the thermal conditioning system, the electric aircraft, or equipment surrounding either the conditioning system or the electric aircraft when, for example, circumstances result in an overload of the handle that couples the conduits to the electric aircraft. An accidental overload can occur, for example, by an operator falling on the handle, or the electric aircraft, another ground-based vehicle or other equipment, dragging the conduits attached to the handle.

### BRIEF DESCRIPTION

All aspects, examples and features mentioned below can be combined in any technically possible way.

An aspect of the disclosure includes a breakaway port for a thermal conditioning system for an electric aircraft, the breakaway port comprising: a mounting member including at least one port for a thermal conditioning liquid, the at least one port configured to fluidly communicate with a liquid-based thermal conditioning circuit in the electric aircraft; a breakaway member; at least one fitting coupled to the breakaway member and configured to liquidly couple to at least one of a thermal conditioning liquid inlet conduit and a thermal conditioning liquid outlet conduit; and at least one breakaway retainer coupling the breakaway member to the mounting member, the at least one breakaway retainer configured to separate to decouple the breakaway member from the mounting member in response to a predetermined force being applied to the at least one breakaway retainer.

Another aspect of the disclosure includes any of the preceding aspects, and further comprising a sealing member between the mounting member and the breakaway member, the sealing member configured to seal between the at least one port and the at least one fitting.

Another aspect of the disclosure includes any of the preceding aspects, and the mounting member is configured to be mounted to the electric aircraft.

Another aspect of the disclosure includes any of the preceding aspects, and further comprising a connection member extending from the breakaway member, the connection member including a connection element configured to selectively connect to a locking system of a handle to secure the handle to the electric aircraft, wherein the handle couples the thermal conditioning liquid inlet conduit and the thermal conditioning liquid outlet conduit together.

Another aspect of the disclosure includes any of the preceding aspects, and the at least one fitting includes an inlet fitting coupled to the thermal conditioning liquid inlet conduit and an outlet fitting coupled to the thermal conditioning liquid outlet conduit, and wherein the inlet fitting, the outlet fitting and the breakaway member decouple as a unit from the mounting member in response to the predetermined force being applied to the at least one breakaway retainer.

Another aspect of the disclosure includes any of the preceding aspects, and the connection member interacts with an alignment feature on the handle to align the thermal conditioning liquid inlet conduit with the inlet fitting and the thermal conditioning liquid outlet conduit with the outlet fitting.

Another aspect of the disclosure includes any of the preceding aspects, and the locking system includes a plurality of arms pivotally coupled to a latching member configured to engage the connection element.

Another aspect of the disclosure includes any of the preceding aspects, and the inlet fitting and the outlet fitting are threadedly coupled to the breakaway member.

Another aspect of the disclosure includes any of the preceding aspects, and each breakaway retainer includes a threaded fastener, whereby each threaded fastener couples the breakaway member to the mounting member.

Another aspect of the disclosure includes any of the preceding aspects, and each breakaway retainer includes a snap retainer configured to couple the breakaway member to the mounting member.

Another aspect of the disclosure includes any of the preceding aspects, and each breakaway retainer includes a post extending from the mounting member through a retainer opening in the breakaway member, and a retaining member engaging the post and sized to prevent removal of the post through the retainer opening.

Another aspect of the disclosure includes any of the preceding aspects, and further comprising a sensor configured to transmit a signal to the thermal conditioning system to cease transmission of the thermal conditioning liquid to the electric aircraft in response to decoupling of the breakaway member from the mounting member.

Another aspect of the disclosure includes an electric aircraft, comprising: a propulsor; an energy source configured to power the propulsor; a breakaway port for coupling a thermal conditioning system to the energy source for thermally conditioning the energy source, the breakaway port including: a mounting member including at least one port for a thermal conditioning liquid, the at least one port configured to fluidly communicate with a liquid-based thermal conditioning circuit in the electric aircraft; a breakaway member; at least one fitting coupled to the breakaway member and configured to liquidly couple to at least one of a thermal conditioning liquid inlet conduit and a thermal conditioning liquid outlet conduit; a sealing member between the mounting member and the breakaway member, the sealing member configured to seal between the at least one port and the at least one fitting; and at least one breakaway retainer coupling the breakaway member to the mounting member, the at least one breakaway retainer configured to separate to decouple the breakaway member from the mounting member in response to a predetermined force being applied to the at least one breakaway retainer.

Another aspect of the disclosure includes any of the preceding aspects, and the mounting member is configured to be mounted to the electric aircraft.

Another aspect of the disclosure includes any of the preceding aspects, and further comprising a connection member extending from the breakaway member, the connection member including a connection element configured to selectively connect to a locking system of a handle to secure the handle to the electric aircraft, wherein the handle couples the thermal conditioning liquid inlet conduit and the thermal conditioning liquid outlet conduit together.

Another aspect of the disclosure includes any of the preceding aspects, and the locking system includes a plurality of arms pivotally coupled to a latching member configured to engage the connection element.

Another aspect of the disclosure includes any of the preceding aspects, and the at least one fitting includes an inlet fitting coupled to the thermal conditioning liquid inlet conduit and an outlet fitting coupled to the thermal conditioning liquid outlet conduit, and wherein the inlet fitting, the outlet fitting and the breakaway member decouple as a unit from the mounting member in response to the predetermined force being applied to the at least one breakaway retainer.

Another aspect of the disclosure includes any of the preceding aspects, and the connection member interacts with an alignment feature on the handle to align the thermal conditioning liquid inlet conduit with the inlet fitting and the thermal conditioning liquid outlet conduit with the outlet fitting.

Another aspect of the disclosure includes any of the preceding aspects, and each breakaway retainer includes a threaded fastener, whereby each threaded fastener couples the breakaway member to the mounting member.

Another aspect of the disclosure includes any of the preceding aspects, and each breakaway retainer includes a snap retainer configured to couple the breakaway member to the mounting member.

Another aspect of the disclosure includes any of the preceding aspects, and each breakaway retainer includes a post extending from the mounting member through a retainer opening in the breakaway member, and a retaining member engaging the post and sized to prevent removal of the post through the retainer opening.

Another aspect of the disclosure includes any of the preceding aspects, and further comprising a sensor configured to transmit a signal to the thermal conditioning system to cease transmission of the thermal conditioning liquid to the electric aircraft in response to decoupling of the breakaway member from the mounting member.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of an illustrative electric aircraft environment for a breakaway port according to embodiments of the disclosure;

FIG. 2 shows a perspective view of a port location of an electric aircraft for a breakaway port with a handle in an operating state according to embodiments of the disclosure;

FIG. 3 shows a perspective view of a breakaway port with a handle of a thermal conditioning system in a decoupled state according to embodiments of the disclosure;

FIG. 4 shows a partial cross-sectional view of a handle of a thermal conditioning system according to embodiments of the disclosure;

FIG. 5 shows an end view of a breakaway port according to embodiments of the disclosure;

FIG. 6A shows a cross-sectional side view of a breakaway port along view line 6A-6A in FIG. 5 according to embodiments of the disclosure;

FIG. 6B shows a cross-sectional side view of a breakaway port along view line 6B-6B in FIG. 5 according to embodiments of the disclosure;

FIG. 7 shows an exploded view of a breakaway port according to embodiments of the disclosure;

FIG. 8 shows a top-down view of a breakaway port according to embodiments of the disclosure;

FIG. 9A shows a cross-sectional side view (similar to FIG. 6A) of a breakaway port after a predetermined force has been applied and causing breakaway retainer(s) thereof to break and a handle is partially retracted from the port, according to embodiments of the disclosure;

FIG. 9B shows a cross-sectional side view (similar to FIG. 6B) of a breakaway port after a predetermined force has been applied and causing breakaway retainer(s) thereof to break and a handle is partially retracted from the port, according to embodiments of the disclosure;

FIG. 10A shows a cross-sectional side view (similar to FIG. 6A) of a breakaway port after a predetermined force has been applied and a handle is more fully retracted from the port, according to embodiments of the disclosure;

FIG. 10B shows a cross-sectional side view (similar to FIG. 6B) of a breakaway port after a predetermined force has been applied and a handle is more fully retracted from the port, according to embodiments of the disclosure;

FIGS. 11A-B show cross-sectional views of parts of a locking system for a breakaway port and a handle along view line 11-11 in FIG. 8 in an engaged and unengaged position, respectively, according to embodiments of the disclosure;

FIG. 12A shows a top-down view and FIG. 12B shows an end view of a breakaway port including at least one breakaway retainer according to an alternative embodiment of the disclosure; and

FIG. 13A shows a top-down view and FIG. 13B shows an end view of a breakaway port including at least one breakaway retainer according to another alternative embodiment of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current technology, it will become necessary to select certain terminology when referring to and describing relevant machine components within the illustrative application of an electric aircraft and/or a thermal conditioning system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a liquid, such as the coolant through a conduit or cooling circuit. The term “downstream” corresponds to the direction of flow of the liquid, and the term “upstream” refers to the direction opposite to the flow.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, indicate the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure include a breakaway port for a thermal conditioning system for an electric aircraft and an electric aircraft including, among other things, the breakaway port. The breakaway port includes a mounting member including at least one port, e.g., an inlet port and an outlet port, for a thermal conditioning liquid. The at least one port fluidly communicate with a liquid-based thermal conditioning circuit in the electric aircraft, e.g., a liquid cooling circuit for the energy source of the electric aircraft. A breakaway member is coupled to the mounting member. At least one fitting is coupled to the breakaway member and liquidly couples to at least one liquid conduit. For example, an inlet fitting may be coupled to the breakaway member and liquidly couple to a liquid inlet conduit, and an outlet fitting may be coupled to the breakaway member and couple to a liquid outlet conduit. A sealing member is between the mounting member and the breakaway member to seal between the at least one port and the at least one fitting, e.g., the inlet port and inlet fitting and the outlet port and the outlet fitting. Breakaway retainer(s) couple the breakaway member to the mounting member and separate to decouple the breakaway member from the mounting member in response to a predetermined force being applied to the breakaway retainer(s). The breakaway port provides un-impinged flow of thermal conditioning liquid, e.g., a coolant, from the port to the electric aircraft, and provides for breakaway for atypical load cases (e.g., aircraft departing with the handle still attached, or operators falling on the mechanism). The breakaway port ensures de-coupling occurs between the handle that couples the inlet and outlet conduits and the aircraft. The breakaway port thus prevents any accidental damage to the electric aircraft, thermal conditioning system and/or surrounding equipment in response to load over the predetermined force.

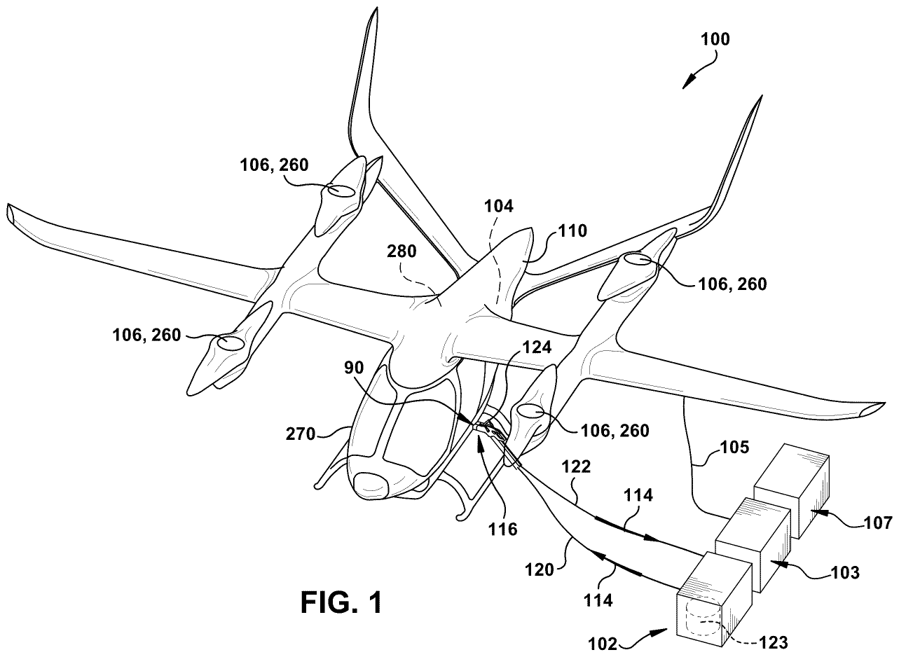

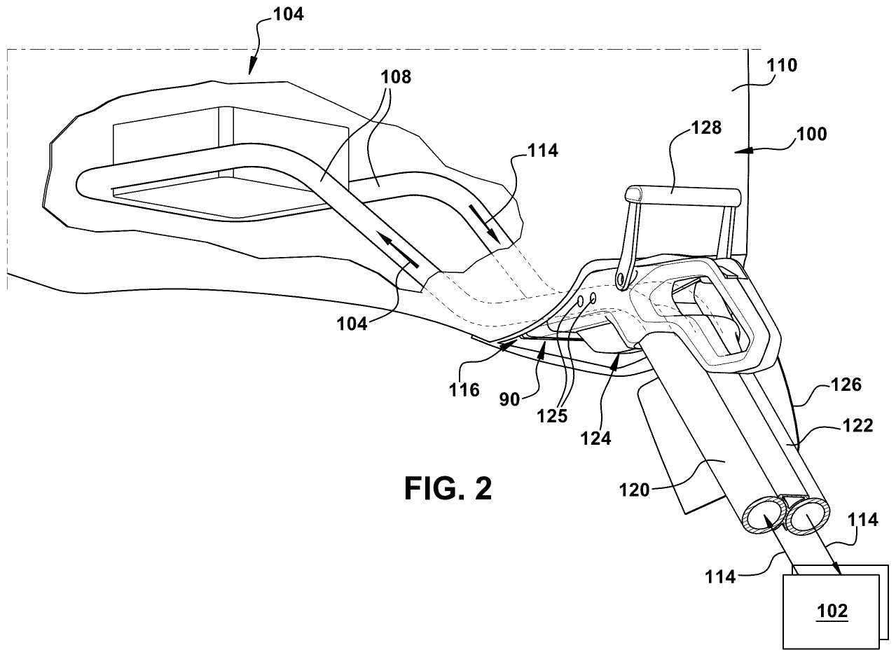

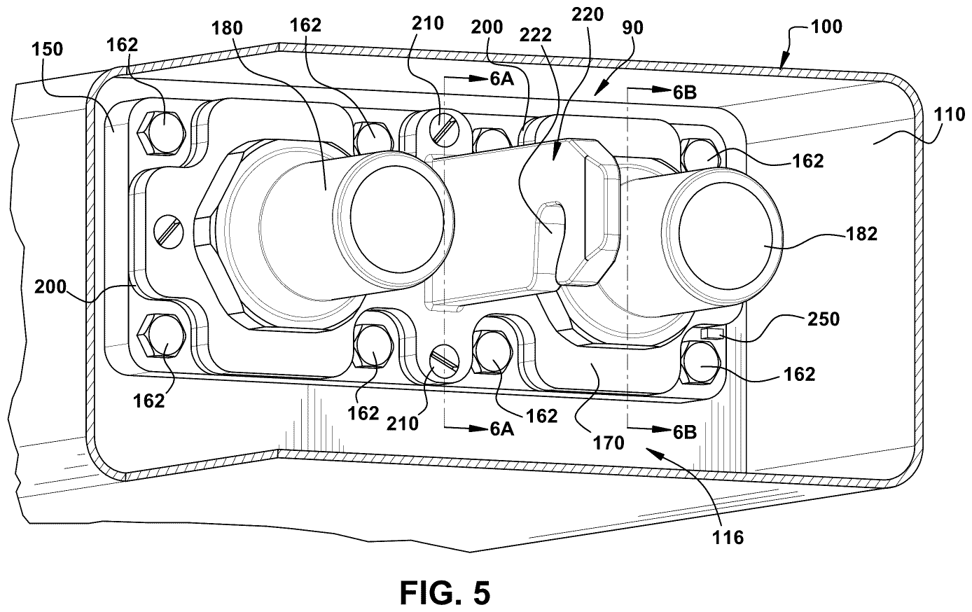

FIG. 1 shows a perspective view of an illustrative environment in which a breakaway port 90 (hidden in FIGS. 1-2, shown in FIGS. 5-8) according to embodiments of the disclosure is used on an electric aircraft 100. While embodiments of the disclosure will be described relative to electric aircraft 100 environment, it will be understood that breakaway port 90 (FIGS. 5-8) may be applicable in a wide variety of other environments in which prevention of accidental damage to a vehicle, a ground-based liquid thermal conditioning system or other equipment is desired.

A brief introduction of electric aircraft 100 and parts of a ground-based thermal conditioning system 102 relevant to breakaway port 90 will now be provided. Further details of electric aircraft 100 are provided herein. As used in this disclosure an “aircraft” or “electric aircraft” is a vehicle that may fly. As a non-limiting example, electric aircraft 100 may include airplanes, helicopters, airships, blimps, gliders, paramotors, or similar vehicles. More particularly, electric aircraft 100 may include any now known or later developed vehicle that includes one or more propulsors 106 and an energy source 104, such as a battery or battery pack, configured to power propulsor(s) 106. Electric aircraft 100 also has a fuselage 110 that encloses, among other things, energy source 104. As will be described herein, propulsor(s) 106 may be one of a number of actuators on electric aircraft 100. As shown in FIG. 1, electric aircraft 100 may also operatively couple to charging system 103 through a separate charging cable 105. A central control system 107 may alone, or in conjunction with control systems on electric aircraft 100, control and/or coordinate operation of conditioning system 102 and/or charging system 103.

For purposes of description, energy source 104 may include a single battery or a battery pack. Different types of energy sources 104 will be described elsewhere herein. As recognized in the field, and as partially shown in the perspective view of FIG. 2, a liquid-based thermal conditioning circuit 108 controls a thermal condition, e.g., overall temperature or other thermal attribute, of energy source 104. Liquid-based thermal conditioning circuit 108 (hereafter “circuit 108” for brevity) may include any now known or later developed circuit to, for example, cool and/or heat energy source 104. In one non-limiting example, circuit 108 may include conduits, such as pipes, to fluidly communicate a thermal conditioning liquid 114 around at least part of energy source 104, and may also include various heat exchangers, manifolds, pumps, valves, orifices, couplings, and/or any related sensors and control systems. Circuit 108 may take any path in and around at least part of energy source 104 but returns to a port location 116 at an exterior of fuselage 110 where it fluidly couples to a ground-based thermal conditioning system 102.

Ground-based thermal conditioning system 102 (hereafter “conditioning system 102”) may include any now known or later developed system to provide thermal conditioning liquid 114 to circuit 108. More particularly, conditioning system 102 may include any now known or later developed hardware and/or software to provide thermal conditioning liquid 114 at a controlled temperature and rate, such as but not limited to: pumps, filters, chillers, heaters, sensors, valves. Conditioning system 102 and/or electric charging system 103 may also include any necessary central control systems 107 which may be optionally in electrical communication with sensors and/or control systems in electric aircraft 100. Liquid 114 may include any now known or later developed liquid capable of the required heat transfer characteristics. In non-limiting examples, liquid 114 may include water, anti-freeze like propylene glycol, thermal oil, etc.

Conditioning system 102 may be coupled to electric aircraft 100 using a pair of conduits 120, 122 that may be coupled to a handle 124 for ease of handling and attaching to electric aircraft 100. Conduits 120, 122 may include any variety of hoses or tubes (e.g., flexible hoses or tubes) for conveying liquid 114 and are typically of sufficient strength to withstand exposure to repeated flexing, ground contact and environmental conditions. Although wireless communications with control systems within electric aircraft 100 are an option, any necessary electrical connections (not shown) may also be routed with conduits 120, 122 and through handle 124. Conduits 120, 122 may be selectively fed into and/or out of a storage system (not shown) in conditioning system 102. For example, conditioning system 102 may include a powered reel 123 (FIG. 1) within a housing thereof with controls 125 (FIG. 2) therefor on handle 124. For purposes of description, and with reference to liquid 114 flow relative to electric aircraft 100, conduit 120 may be referred to as a thermal conditioning liquid inlet conduit (hereafter “inlet conduit 120”) and conduit 122 may be referred to as a thermal conditioning liquid outlet conduit (hereafter “outlet conduit 122”). It is understood that the positions of each conduit in the drawings may be switched, and that more than two conduits may also be employed by duplicating structure described herein.

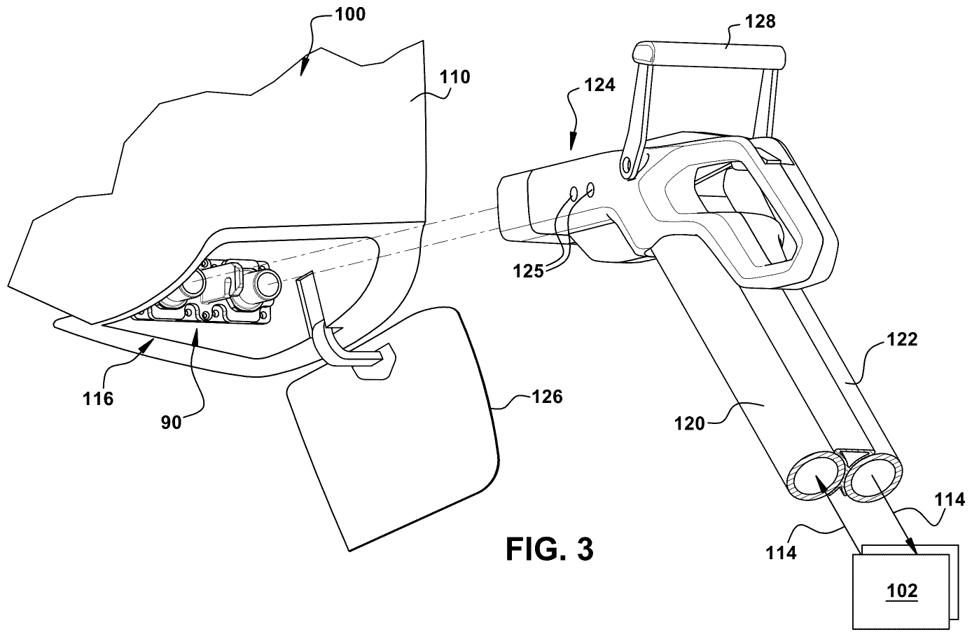

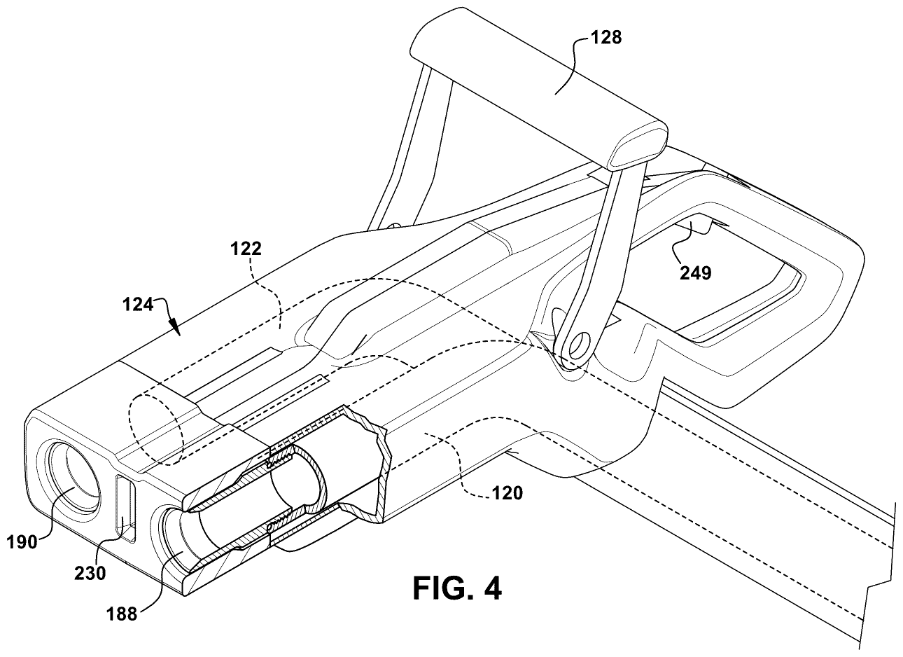

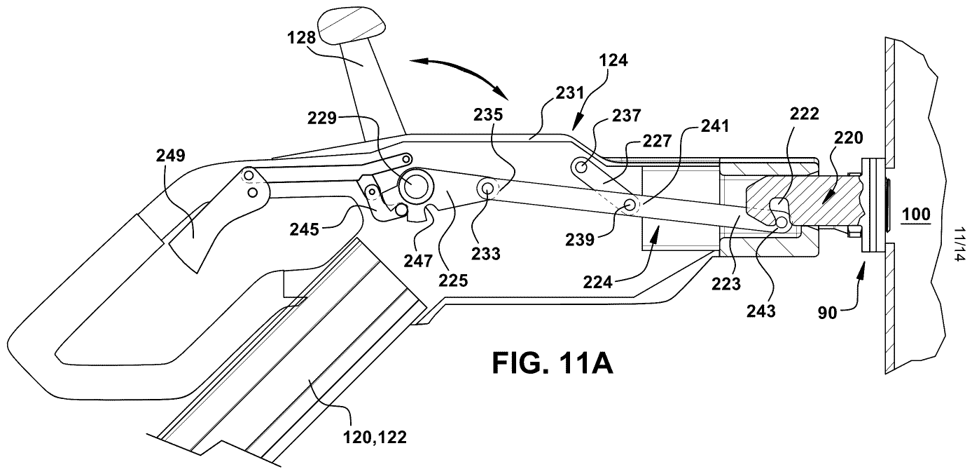

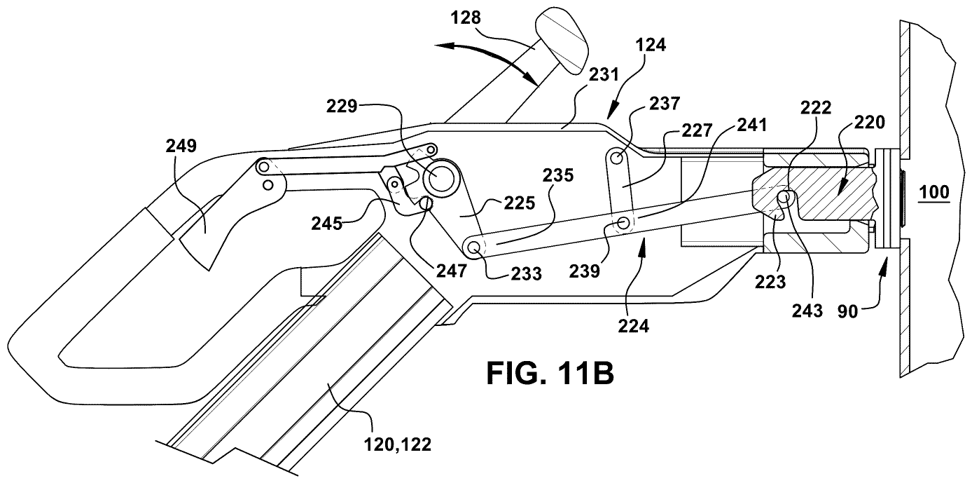

FIG. 3 shows a perspective view of breakaway port 90 with handle 124 decoupled from electric aircraft 100, and FIG. 4 shows a partial cross-sectional view of handle 124, according to embodiments of the disclosure. As shown in FIG. 3, fuselage 110 may optionally include a door 126 for accessing port location 116. Door 126 may include any now known or later developed selectively openable access door (e.g., similar to a lockable fuel door on an automobile) capable of withstanding the aerodynamic forces of electric aircraft 100 during operation. With reference to FIGS. 2-4, handle 124 may include any now known or later developed system to attach inlet and outlet conduits 120, 122 and allow collective handling and attachment to breakaway port 90 (FIGS. 5-8) according to embodiments of the disclosure. Handle 124 may optionally include an actuator 128 for activating a locking system 224 (FIGS. 11A-B) for fastening handle 124 to breakaway port 90 (FIGS. 5-8), as will be further described herein. Handle 124 may be made of any appropriate metal, metal alloy and/or hard plastic capable of withstanding, for example: environmental conditions; repeated movement, dropping, hitting and abrasion; and forces applied by conduits 120, 122 and movement of actuator 128, during use. Further details of handle 124 will be described herein.

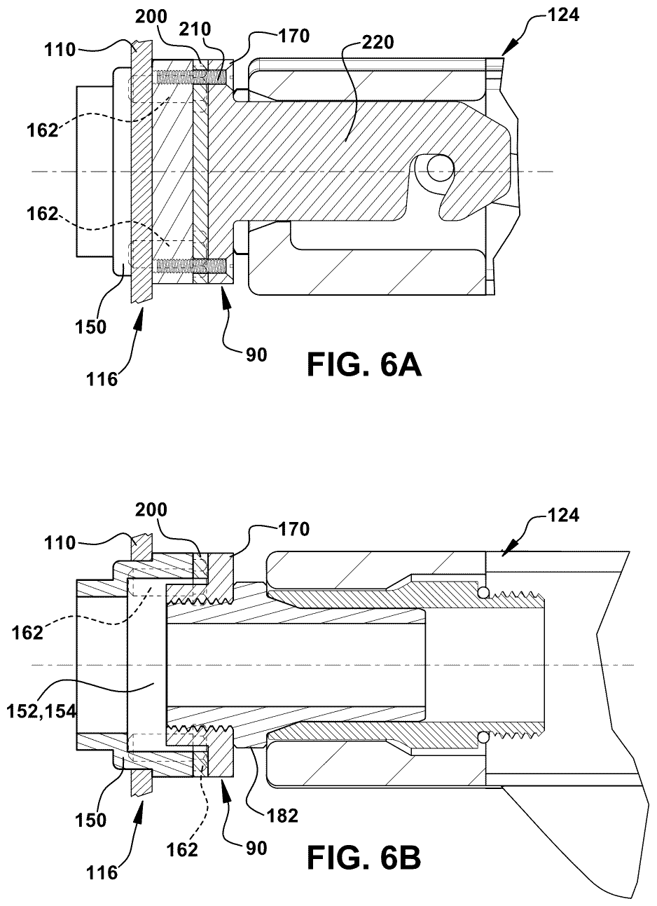

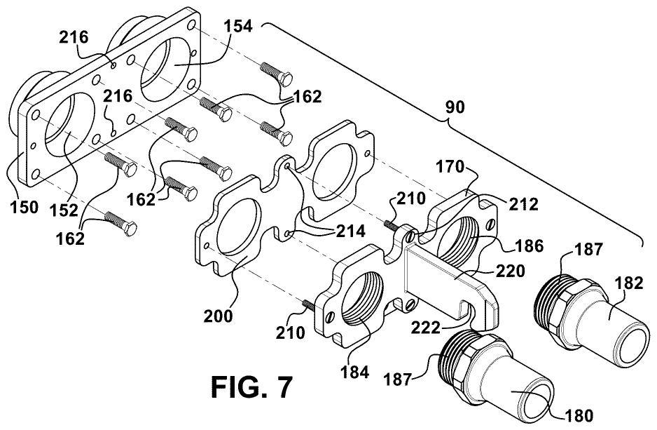

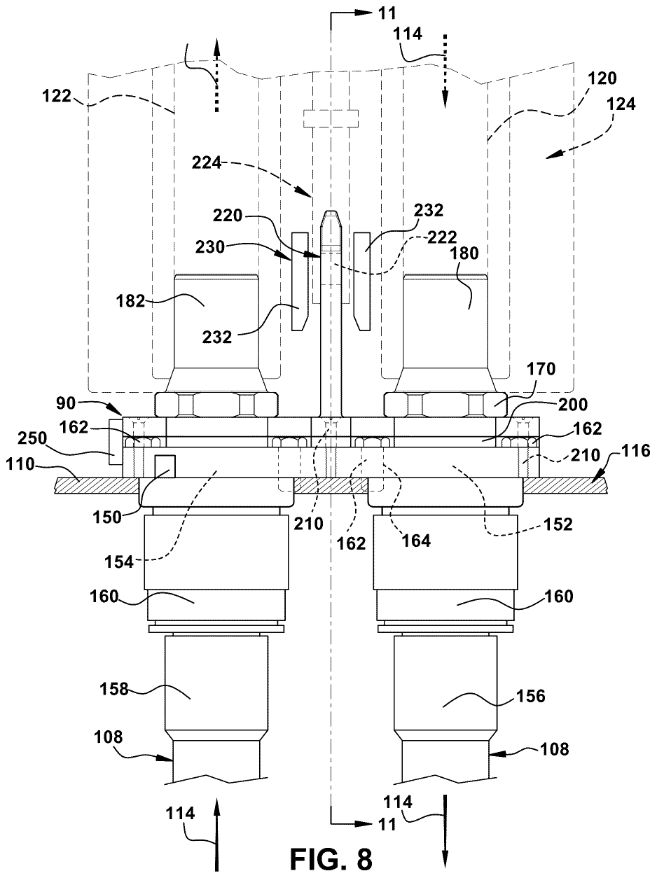

FIGS. 5-8 show various views of breakaway port 90 for conditioning system 102 for electric aircraft 100. More particularly, FIG. 5 shows an end view, FIGS. 6A-B show cross-sectional side views, FIG. 7 shows an exploded view, and FIG. 8 shows a top-down view of breakaway port 90 according to embodiments of the disclosure.

Breakaway port 90 includes a mounting member 150 for mounting to and interfacing with electric aircraft 100. Mounting member 150 may also be referenced as an aircraft interface bracket. As shown in FIG. 7, mounting member 150 includes at least one port for thermal conditioning liquid. For description purposes, the at least one port will be described as including an inlet port 152 and an outlet port 154 for thermal conditioning liquid 114. However, it will be recognized that a single port (e.g., 152 or 154) can also be used at a given location, perhaps with another port (e.g., 154 or 152) at another location. In this case, each port may include features of breakaway port 90 as described herein. In addition, breakaway port 90 may also include more than two ports 152, 154. As shown in FIG. 8, inlet port 152 and outlet port 154 are configured to fluidly communicate with circuit 108 in electric aircraft 100. For example, inlet port 152 and outlet port 154 may couple to respective conduits 156, 158 of circuit 108, respectively, using any now known or later developed couplers 160. Conduits 156, 158 may include any fluid conducting conduits that are part of circuit 108 and are routed to port location 116. Couplers 160 may include but are not limited to: solderable male-female pipe fittings, pipe unions, quick connect fasteners, and one-piece pipe thermal expansion pipe joints. As shown in FIGS. 5, 7 and 8, mounting member 150 may be coupled to any variety of structural element(s) of fuselage 110 using, for example, any number of threaded fasteners 162 in corresponding holes 164 in mounting member 150. While fasteners 162 are shown as threaded screws, any form of fixing fastener may be used including but not limited to screws, bolts, rivets and/or welds. Fasteners 162 may be made of any material configured to support loads significantly greater than breakaway retainers 210, described herein, such as but not limited steel or stainless steel.

Mounting member 150 may be configured to be mounted to electric aircraft 100 in any manner. For example, mounting member 150 can be sized and have holes 164 positioned to couple to structural elements of fuselage 110 for any type and/or size of electric aircraft 100. Further, port(s) 152, 154 of mounting member 150 may be customized to accommodate a variety of different thermal conditioning circuit 108 arrangements in different electric aircraft 100. For example, the dimensions, position and/or fittings of mounting member 150 for port(s) 152, 154 can be adjusted to accommodate any circuit 108 and related conduits 156, 158 thereof.

Breakaway port 90 also includes a breakaway member 170. As will be further described, breakaway member 170 is coupled to mounting member 150. Mounting member 150 and breakaway member 170 may be made of any metal or metal alloy having sufficient strength for their intended purposes. In non-limiting examples, mounting member 150 and/or breakaway member 170 may be made of 6061 or 7075 aluminum, steel, titanium, or other metals. Members 150, 170 may be formed using any now known or later developed process such as machining from a block material and/or additive manufacture.

Breakaway port 90 also includes at least one fitting coupled to breakaway member 170 and configured to liquidly couple to a conduit (e.g., in handle 124, see FIG. 8). For purposes of description, breakaway port 90 is described as including an inlet fitting 180 coupled to breakaway member 170 and configured to liquidly couple to inlet conduit 120 (e.g., in handle 124, see FIG. 8), and an outlet fitting 182 coupled to breakaway member 170 and configured to liquidly couple to outlet conduit 122 (e.g., in handle 124, see FIG. 8). However, as with port(s) 152, 154, a single fitting may be used perhaps with another breakaway port 90 with a single port/fitting in another location on the vehicle. As shown in FIG. 7, fittings 180, 182 may be coupled to breakaway member 170 in a first opening 184 and a second opening 186, respectively, in breakaway member 170. In certain embodiments, fitting(s), e.g., inlet fitting 180 and outlet fitting 182, may be threadedly coupled to breakaway member 170. More particularly, fitting(s) 180, 182 may be coupled to breakaway member 170 using, for example, a threaded connection 187 (FIG. 7). However, other coupling mechanisms such as welding, soldering, etc., are also possible. Inner ends of fittings 180, 182 are aligned with ports 152, 154 in mounting member 150, but do not extend into ports 152, 154.

Fitting(s) 180, 182 may include any mechanism or part of a mechanism to sealingly couple with conduit(s) 120, 122 in handle 124. As shown in FIG. 4, handle 124 may include mating fitting(s) 188, 190 that sealingly mate with fitting(s) 180, 182 (FIG. 5) on breakaway member 170. Fitting(s) 180, 182 and/or fitting(s) 188, 190 may optionally include any now known or later developed stop or check valve (not shown) to prevent leaking of liquid 114 from circuit 108, handle 124 and/or conditioning system 102. Collectively, matching fittings 180, 188 and 182, 190 may include any now known or later developed quick connect pipe fittings including, for example, mating male-female conduit portions with sealing O-rings. Fittings 180, 182, 188, 190 may be made of, for example, any of the materials listed herein for mounting member 150 or breakaway member 170. Fitting 180, 182, 188, 190 may be commercially available fitting such as but not limited to Cold Product Corporation (CPC) model Everis™ BLQ10 fittings.

Referring again to FIGS. 5-8, breakaway port 90 also may optionally include a sealing member 200 between mounting member 150 and breakaway member 170. Where necessary, sealing member 200 is configured to seal between inlet port 152 in mounting member 150 and inlet fitting 180 on breakaway member 170 and outlet port 154 in mounting member 150 and outlet fitting 182 on breakaway member 170. Sealing member 200 may be sized and shaped to ensure sealing of liquid 114 as noted. Sealing member 200 may be made of any sealing material rated for the desired loads and temperature range such as but not limited to silicone rubber. Sealing member 200 can be configured to have a fixed structure such as a sealing washer or gasket, but this is not necessary in all cases. Where mounting member 150 and breakaway member 170 can seal without the presence of a sealing member 200, it may be omitted.

Breakaway port 90 also includes at least one breakaway retainer 210 coupling or retaining breakaway member 170 to mounting member 150. In certain embodiments, breakaway retainer(s) 210 extend through hole(s) 212 in breakaway member 170, hole(s) 214 in sealing member 200 and (capturing) hole(s) 216 in mounting member 150. Breakaway retainer(s) 210 are configured to separate to decouple breakaway member 170 from mounting member 150 in response to a predetermined force F1 being applied to breakaway retainer(s) 210. In certain embodiments, each breakaway retainer 210 includes a threaded fastener (shown) configured to break at predetermined force F1. In this manner, the threaded fastener(s) can readily and easily couple breakaway member 170 to mounting member 150 but break at predetermined force F1. Alternatively, as will be further described herein, breakaway retainer(s) 210 may include any coupler, retainer and/or fastener such as but not limited to: one or more clips, one or more retaining tabs or rings, an interference fit pin or other fastener, configured to couple or retain members 150, 170 together but break at predetermined force F1. As used herein, “break” as applied to breakaway retainer(s) 210 means that retainer(s) 210 de-couple from mounting member 150 or otherwise separate into two or more parts. In this manner, breakaway member 170 is no longer coupled to mounting member 150 and conduits 120, 122 (e.g., with handle 124) can safely pull away from port location 116 and electric aircraft 100 without causing damage to electric aircraft 100, handle 124, conditioning system 102 or any other adjacent equipment to those structures. Breakaway retainer(s) 210 may be designed to break at predetermined force F1 based on at least one of the following characteristics thereof: a material thereof having strength less than mounting member 150, breakaway member 170 or fasteners 162, and/or weaker areas having, for example, reduced dimensions such as a reduced diameter. The materials and/or weak areas may be in all or part of breakaway retainer(s) 210. Prior to breaking, breakaway retainer(s) 210 may also compress sealing member 200, where provided, between mounting member 150 and breakaway member 170 to form a seal. While two breakaway retainers 210 are shown, any number may be used and breakaway member 170, sealing member 200 and mounting member 150 may have corresponding hole(s) 212, 214, 216 to accommodate them.

As shown in FIGS. 5 and 7, breakaway port 90 may also optionally include a connection member 220 extending from breakaway member 170. Connection member 220 may include a connection element 222, e.g., a seat, a hook, or shape therein, configured to selectively connect handle 124 to breakaway member 170 using a locking system 224 in handle 124. FIGS. 11A-B show cross-sectional views of parts of breakaway port 90 and handle 124 along a view line 11-11 in FIG. 8, i.e., extending along connection member 220, according to embodiments of the disclosure. As shown, handle 124 may include any form of locking system 224, e.g., a pivoting pin, actuatable by actuator 128 to engage connection element 222 and hold handle 124 to breakaway port 90, i.e., breakaway member 170. In this manner, as shown in FIGS. 2 and 8-10, handle 124 couples inlet conduit 120 and outlet conduit 122 together to breakaway member 170. More particularly, handle 124 couples inlet conduit 120 and outlet conduit 122 to fitting(s) 180, 182, e.g., inlet fitting 180 and outlet fitting 182, respectively, of breakaway port 90.

In FIGS. 11A-B, connection member 220 includes connection element 222 configured to selectively connect to locking system 224 of handle 124 to secure handle 124 to electric aircraft 100. As noted, handle 124 couples thermal conditioning liquid inlet conduit 120 and thermal conditioning liquid outlet conduit 122 together, i.e., for ease of handling. In certain embodiments, locking system 224 includes a plurality of arms 225, 227 pivotally coupled to a latching member 223 configured to engage connection element 222. More particularly, locking system 224 may include a latching member 223, a first arm 225 and a second arm 227. First arm 225 is rotatably coupled at a first end 229 thereof to rotate with actuator 128 in a housing 231 of handle 124. First arm 225 also includes a second end 233 pivotally coupled to a first end 235 of latching member 223. Second arm 227 has a first end 237 rotatably fixed in housing 226 and a second end 239 pivotally coupled to a pivot point 241 at an appropriate pivoting location (near or at middle) of latching member 223. In operation, as shown in FIG. 11B, when actuator 128 is rotated clockwise (forwardly) as shown, first arm 225 rotates with actuator 128 and causes first end 235 and pivot point 241 of latching member 223 to pivot or translate downwardly (and counterclockwise). As shown in FIG. 11B, the movement of latching member 223 relative to second arm 227 causes a second end 243 of latching member 223 to engage within connection element 222 of connection member 220. Connection element 222 of connection member 220, second end 243 of latching member 223 and first and second arms 225, 227 can be configured to ensure connection member 220 is engaged and secured by latching member 223 to ensure a secure connection of handle 124 to electric aircraft 100 and breakaway port 90. As a result, handle 124 couples inlet conduit 120 and outlet conduit 122 to inlet fitting 180 and outlet fitting 182. The reverse movement of actuator 128 counterclockwise or rearwardly from that shown in FIG. 11B to that shown in FIG. 11A, reverses the action described to disengage handle 124 from connection member 220, and decouple inlet conduit 120 and outlet conduit 122 from inlet fitting 180 and outlet fitting 182. Locking system 224 may be spring-biased, e.g., by a coil spring on any pivot point, into an engaged and/or disengaged position, as desired. Locking system 224 may also include a latch 245 that engages a notch 247 in first arm 225 in the engaged position in FIG. 11B to prevent locking system 224 from moving and maintain locking system 224 in the engaged position, preventing accidental release of locking system 224. A button 249 may be operatively coupled to latch 245 to release it from notch 247 using any now known or later developed connection arms (not numbered), thus allowing locking system 224 to move to the disengaged position shown in FIG. 11A, and allowing removal of handle 124 from breakaway port 90. Latch 247 and button 249 may also be spring biased to the engaging position with first arm 225. While a particular locking system 224 for handle 124 and connection member 220 has been illustrated, it will be recognized that a wide variety of alternative mechanisms are also possible.

As shown in FIG. 8 (see also FIG. 4), connection member 220 may interact with an alignment feature 230 on handle 124 to align inlet conduit 120 with inlet fitting 180 and outlet conduit 122 with outlet fitting 182. Alignment feature 230 may include any structure capable of positioning connection member 220 in desired location such as but not limited to a pair of parallel plates 232 configured to received connection member 220 therebetween. Fittings 180, 188 and 182, 190 may also include any now known or later developed alignment features.

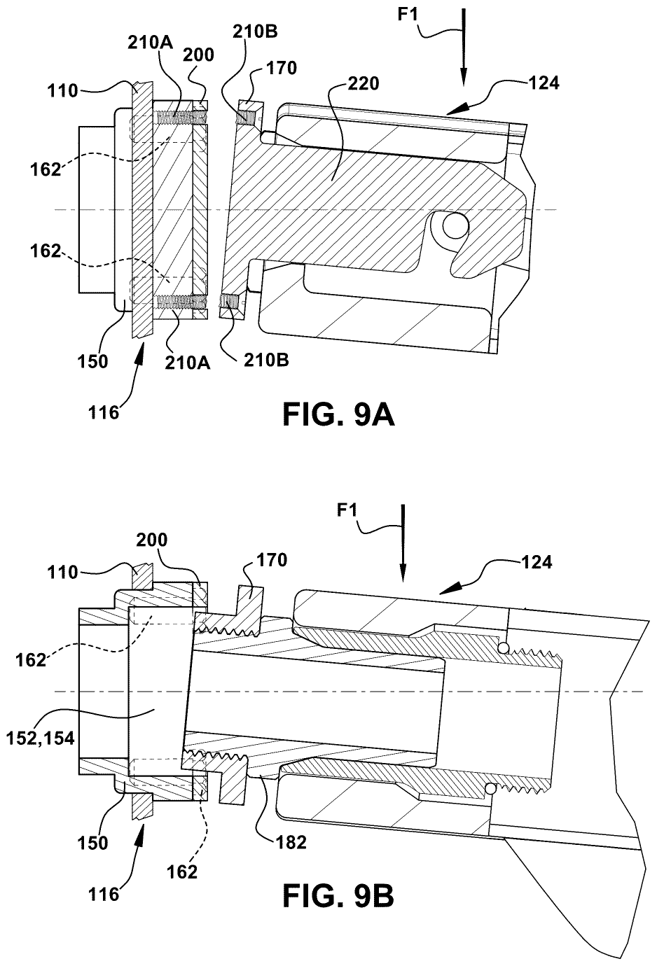

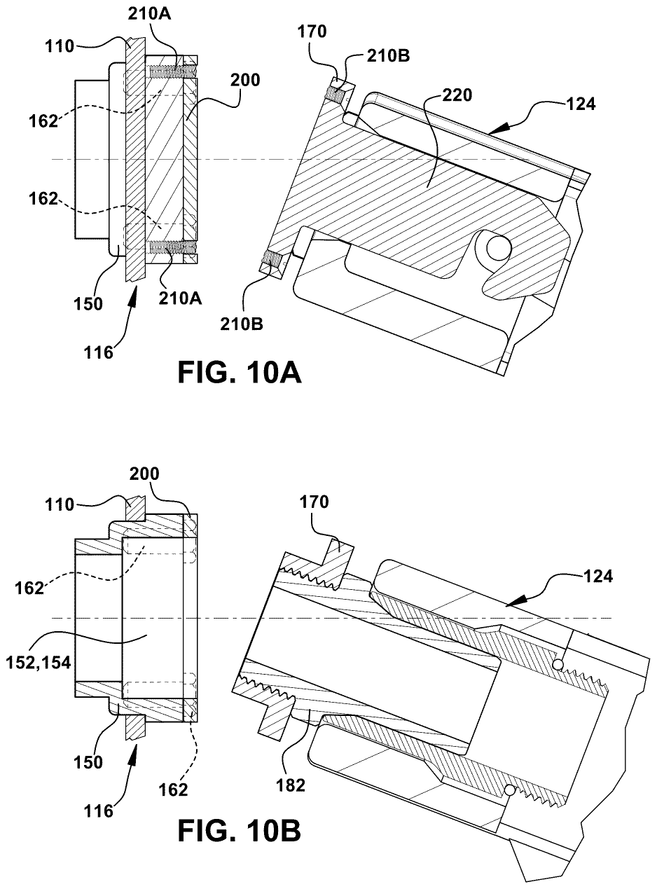

FIGS. 9A-B show cross-sectional side views (similar to FIGS. 6A-B) of breakaway port 90 after a predetermined force F1 has been applied to breakaway port 90, causing breakaway retainer(s) 210 to break. FIGS. 10A-B show cross-sectional side views (similar to FIGS. 6A-B and 9A-B) of breakaway port 90 after predetermined force F1 (FIGS. 9A-B) has been applied and handle 124 is more fully retracted from the port. The predetermined force F1 can be user defined to accommodate potential scenarios that may vary depending on attributes of, for example, electric aircraft 100 (e.g., size like wing height, door 126 location, circuit 108 and conduit 120, 122 size and weight, circuit 108 safety features), conditioning system 102 (e.g., location, type of liquid 114 used, capacity, safety features, etc.), geographic location (e.g., summer or winter locations), and/or anticipated user experience with, among other things, conditioning system 102. Predetermined force F1 may be configured on an anticipated accidental force F2 (not in drawings) that may be accidentally applied to handle 124 and/or conduits 120, 122 of conditioning system 102. Accidental force F2 is not necessarily the same as predetermined force F1, but predetermined force F1 would be correlated to accidental force F2 to prevent damage should an accident applying accidental force F2 occur. In any event, inlet fitting 180, outlet fitting 182 and breakaway member 170 decouple as a unit from mounting member 150 in response to predetermined force F1 being applied to breakaway retainer(s) 210.

In certain embodiments, where additional damage has not occurred to handle 124, fittings 180, 182 and/or handle 124 from falling after breakaway retainer(s) 210 are broken, breakaway port 90 may be re-used or reset. In this case, breakaway member 170 may be re-coupled to mounting member 150 with sealing member 200 therebetween (no handle 124 connected) with new breakaway retainer(s) 210, allowing re-use of breakaway port 90.

While holes 164 in mounting member 150 for fasteners 162 and hole(s) 212 in breakaway member 170 for breakaway retainer(s) 210 are shown as countersunk holes, that arrangement is not necessary, i.e., it is not necessary to include countersink holes 164, 212. Further fastener(s) 162 or retainer(s) 210 can have any head arrangement capable of providing the desired fastening of members, e.g., mounting member 150 to electric aircraft 100 and breakaway member 170 to mounting member 150.

While mounting member 150 and breakaway member 170 have been illustrated with dimensions that make them generally plates or brackets, it will be recognized that they may have any thickness required.

In certain embodiments, as shown in FIGS. 5 and 8, breakaway port 90 may also include a sensor 250 configured to transmit a signal to central control system 107 regarding the connection status of handle 124 and/or breakaway port 90. Central control system 107 may start and/or stop liquid 114 pumping according to the connection status indicated by sensor 250. For example, central control system 107 may cease conveyance of liquid 114 to or out of electric aircraft 100 in response to decoupling of breakaway member 170 from mounting member 150 as indicated by sensor 250. Similarly, central control system 107 may not start conveyance of liquid 114 to or out of electric aircraft 100 until sensor 250 indicates proper coupling of handle 124 as indicated by sensor 250. Sensor 250 may include any now known or later developed position sensor coupled to one or more of breakaway member 170 and mounting member 150. Sensor 250 can communicate the signal in any now known or later developed manner, e.g., wirelessly or through wired communications running along conduit(s) 120, 122 or other wired communications to central control system 107.

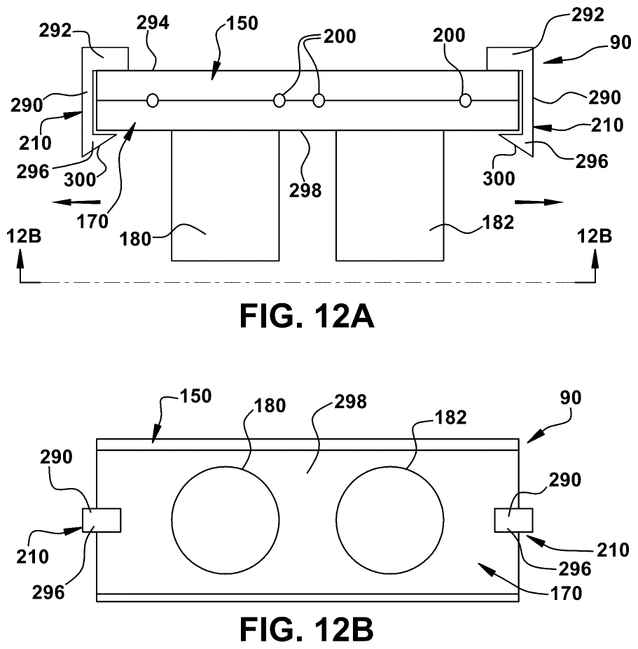

As noted, breakaway port 90 includes at least one breakaway retainer 210 coupling or retaining breakaway member 170 to mounting member 150. Breakaway retainer 210 can take a variety of alternative forms within the scope of the disclosure. FIG. 12A shows a top-down view and FIG. 12B shows an end view of a breakaway port 90 including at least one breakaway retainer 210 according to an alternative embodiment. In FIGS. 12A-B, each breakaway retainer 210 includes a snap retainer 290 configured to couple breakaway member 170 to mounting member 150. More particularly, breakaway retainers 210 include snap retainers 290 having a first end 292 engaging an inner side 294 of mounting member 150 and a second end 296 engaging an outer side 298 of breakaway member 170. Second ends 296 may have ramped surfaces 300 that allow engaging with ends of breakaway member 170 and temporary, flexed expansion of ends 296 (see arrows), while being assembled and until breakaway member 170 is seated within and held in position by snap retainers 290. Snap retainers 290 may be configured to break, as defined herein, at any location in response to a predetermined force F1 being applied to breakaway retainer(s) 210. In one example, ends 296 may break in response to a predetermined force F1 being applied to breakaway retainer(s) 210, which allows breakaway member 170 and handle 124 to decouple as described herein. While two breakaway retainers 210 are shown in FIGS. 12A-B, any number can be used, e.g., one or more than two.

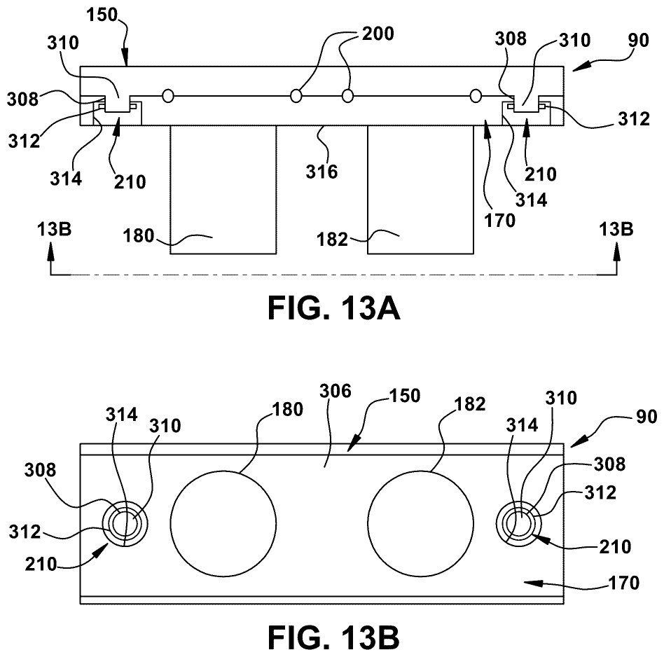

FIG. 13A shows a top-down view and FIG. 13B shows an end view of a breakaway port 90 including at least one breakaway retainer 210 according to another alternative embodiment. In FIGS. 13A-B, each breakaway retainer 210 includes a post 310 extending from mounting member 150 through a retainer opening 308 in breakaway member 170, and a retaining member 312 engaging post 310 and sized to prevent removal of post 310 through retainer opening 308. More particularly, each breakaway retainer 210 includes retainer opening 308 in breakaway member 170, and post 310 extending from mounting member 150 through retainer opening 308. That is, each post 310 extends through a respective retainer opening 308 in breakaway member 170. Breakaway retainers 210 also include retaining member 312 engaging a respective post 310. Retaining members 312 are sized to prevent removal of post 310 through opening 308. Retainer members 312 may include any form of element capable of engaging post 310 at a position to prevent removal of post 310 through a respective retainer opening 308 but able to break in response to predetermined force F1, as described herein, being applied to retainer members 312. As noted, the breaking of breakaway retainers 210 allows breakaway member 170 and handle 124 to decouple as described herein. Retainer members 312 may include but are not limited to: elastic engaging rings (shown), C-clips, U-clips, pins, or Cotter pins. Posts 310 may include any necessary recesses or openings to allow engagement by retainer members 312, e.g., recessed seats, through holes, etc. Retainer openings 308 may be positioned within corresponding recesses 314 in an outer side 316 of breakaway member 170 to position posts 310 and retainer members 312 away from a surface of outer side 316 and allowing handle 124 (not shown) to mate with breakaway member 170, as described herein. However, recesses 314 may not be necessary in all cases, e.g., where handle 124 includes recesses therein to accommodate posts 310 and retainer members 312 extending from breakaway member 170. While two breakaway retainers 210 are shown in FIGS. 13A-B, any number can be used, e.g., one or more than two.

Embodiments of the disclosure also include electric aircraft 100 including breakaway port 90, as described herein.

Returning to FIG. 1, additional description of an illustrative embodiment of electric aircraft 100 is illustrated. Electric aircraft 100 may include any now known or later developed electrically powered aircraft. In some embodiments, such as shown in FIG. 1, electric aircraft 100 includes a vertical takeoff and landing (VTOL) (FIG. 1 shows a lift and cruise VTOL) or a conventional takeoff and landing electric aircraft (CTOL). In some embodiments, electric aircraft 100 may be an electric vertical takeoff and landing (eVTOL) aircraft. An eVTOL, as used herein, is an electrically powered aircraft typically using an energy source or a plurality of energy sources, e.g., battery pack, to power the aircraft. Electric aircraft 100 may be capable of rotor-based cruising flight, rotor-based takeoff, rotor-based landing, fixed-wing cruising flight, airplane-style takeoff, airplane-style landing, and/or any combination thereof. Electric aircraft 100 is illustrated as a rotor-based flight system, e.g., where the aircraft generates lift and propulsion by way of one or more propulsors 106, i.e., powered rotors coupled with a motor, such as a quadcopter, multi-rotor helicopter, or other vehicle that maintains its lift primarily using downward thrusting propulsors. Alternatively, electric aircraft 100 may be arranged for fixed-wing flight, e.g., where the aircraft is capable of flight using wings and/or foils that generate lift caused by the aircraft's forward airspeed and the shape of the wings and/or foils, such as airplane-style flight.

Still referring to FIG. 1, electric aircraft 100 may include a plurality of propulsors 106. In an embodiment, propulsors 106 may be mechanically coupled to electric aircraft 100. The mechanical coupling can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, Hirth joints, hydrodynamic coupling, jaw coupling, magnetic coupling, Oldham coupling, sleeve coupling, tapered shaft lock, twin spring coupling, rag joint coupling, universal joints, or any combination thereof. In an embodiment, mechanical coupling may be used to connect the ends of adjacent parts and/or objects of an electric aircraft. Further, in an embodiment, mechanical coupling may be used to join two pieces of rotating electric aircraft components.

With continued reference to FIG. 1, a plurality of actuators 260 may be configured to produce motion in part of electric aircraft 100. For example, and without limitation, actuators 260 may include propulsors 106 or other forms of actuators (not shown) that may rotate propulsors 106 in an eVTOL or rotate an aileron and/or rudder to generate a force that may adjust and/or affect altitude, airspeed velocity, groundspeed velocity, direction during flight, and/or thrust. For example, plurality of actuators 260 may include a component used to affect the aircrafts' roll and pitch, such as without limitation one or more ailerons in a fixed wing aircraft (not shown), e.g., a hinged surface which form part of the trailing edge of a wing in a fixed wing aircraft (not shown), and which may be moved via mechanical means such as without limitation servomotors, mechanical linkages, or the like. As a further example, plurality of actuators 260 may include a rudder in a fixed wing aircraft (not shown), which may include, without limitation, a segmented rudder that produces a torque about a vertical axis. Additionally or alternatively, plurality of actuators 260 may include other flight control surfaces such as propulsors 106, rotating flight controls, or any other structural features which can adjust movement of aircraft 100. Another illustrative actuator 260 may include landing gear. Landing gear may be used for take-off and/or landing and may be used to contact ground while aircraft 100 is not in flight. Plurality of actuators 260 may also include, for example, one or more rotors, turbines, ducted fans, paddle wheels, and/or other components configured to propel a vehicle through a fluid medium including, but not limited to air.

A propulsor or propulsor component may be any component and/or device used to propel a craft by exerting force on a fluid medium, which may include a gaseous medium such as air or a liquid medium such as water. In an embodiment, when a propulsor twists and pulls air behind it, it may, at the same time, push an aircraft forward with an amount of force and/or thrust. More air pulled behind an aircraft results in greater thrust with which the aircraft is pushed forward. A propulsor 106 may include any device or component that consumes electrical power on demand to propel electric aircraft 100 in a direction or other vehicle while on ground or in-flight. In an embodiment, a propulsor may include a puller component that pulls and/or tows an aircraft through a medium. As a non-limiting example, a puller component may include a flight component such as a puller propeller, a puller motor, a puller propulsor, and the like. Additionally, or alternatively, a puller component may include a plurality of puller flight components. In another embodiment, the propulsor may include a pusher component that pushes and/or thrusts an aircraft through a medium. As a non-limiting example, pusher components may include a pusher component such as a pusher propeller, a pusher motor, a pusher propulsor, and the like. Additionally, or alternatively, a pusher flight component may include a plurality of pusher flight components.

In another embodiment, as shown in FIG. 1, propulsor 106 may include a propeller, a blade, or any combination of the two. A propeller may function to convert rotary motion from an engine or other power source into a swirling slipstream which may push the propeller forwards or backwards. Propulsor(s) 106 may include a rotating power-driven hub, to which several radial airfoil-section blades may be attached, such that an entire whole assembly rotates about a longitudinal axis. As a non-limiting example, a blade pitch of propellers may be fixed at a fixed angle, manually variable to a few set positions, automatically variable (e.g., a constant-speed type), and/or any combination thereof as described further in this disclosure. A fixed angle may be an angle that is secured and/or substantially unmovable from an attachment point. For example, and without limitation, a fixed angle may be an angle of 2.2° inward and/or 1.7° forward. As a further non-limiting example, a fixed angle may be an angle of 3.6° outward and/or 2.7° backward. In an embodiment, propellers for an aircraft may be designed to be fixed to their hub at an angle similar to the thread on a screw makes an angle to the shaft; this angle may be referred to as a pitch or pitch angle which may determine a speed of forward movement as the blade rotates. Additionally, or alternatively, propulsor(s) 106 may be configured having a variable pitch angle. As used in this disclosure a variable pitch angle may be an angle that may be moved and/or rotated. For example, and without limitation, a propulsor component may be angled at a first angle of 3.3° inward, wherein propulsor component may be rotated and/or shifted to a second angle of 1.7° outward.

Still referring to FIG. 1, propulsor(s) 106 may include a thrust element which may be integrated into the propulsor. A thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

Plurality of actuators 260 may include power sources, control links to one or more elements, fuses, and/or mechanical couplings used to drive and/or control any other flight component. Plurality of actuators 260 may include a motor that operates to move one or more flight control components and/or one or more control surfaces, to drive one or more propulsors, or the like. A motor may be driven by direct current (DC) electric power and may include, without limitation, brushless DC electric motors, switched reluctance motors, induction motors, or any combination thereof. Alternatively, or additionally, a motor may be driven by an inverter. A motor may also include electronic speed controllers, inverters, or other components for regulating motor speed, rotation direction, and/or dynamic braking.

Plurality of actuators 260 may include an energy source. An energy source may include, for example, a generator, a photovoltaic device, a fuel cell such as a hydrogen fuel cell, direct methanol fuel cell, and/or solid oxide fuel cell, an electric energy storage device (e.g., a capacitor, an inductor, and/or a battery). As noted herein, an energy source 104 may also include a battery such as a battery cell, or a plurality of battery cells, connected in series into a module and each module connected in series or in parallel with other modules. Configuration of an energy source containing connected modules may be designed to meet an energy or power requirement and may be designed to fit within a designated footprint in electric aircraft 100 in which system may be incorporated. As noted, thermal conditioning circuit 108 may be arranged about any part of energy source 104.

In an embodiment, energy source 104 may be used to provide power in a large variety of situations. Energy source 104 may be used to provide a steady supply of electrical power to a load over a flight by an electric aircraft 100. For example, energy source 104 may be capable of providing sufficient power for cruising and other relatively low-energy phases of flight. Energy source 104 may also be used to provide electrical power to an electric aircraft during moments requiring high rates of power outlet, including without limitation takeoff, landing, thermal de-icing, and situations requiring greater power outlet for reasons of stability, such as high turbulence situations. Energy source 104 may also be capable of providing electrical power for some higher-power phases of flight as well, particularly when the energy source is at a high state of charge (SOC), as may be the case for instance during takeoff. In an embodiment, energy source 104 may include an emergency power unit which may be capable of providing sufficient electrical power for auxiliary loads including without limitation, lighting, navigation, communications, de-icing, steering, or other systems requiring power or energy. Further, energy source 104 may be capable of providing sufficient power for controlled descent and landing protocols, including, without limitation, hovering descent, or runway landing. Energy source 104 may be configured with high power density where electrical power produced per unit of volume and/or mass is relatively high. An energy source may include a device for which power that may be produced per unit of volume and/or mass has been optimized, for instance at an expense of maximal total specific energy density or power capacity.

Non-limiting examples of items that may be used as an energy source may include batteries such as but not limited to: lithium (Li) ion batteries which may include nickel-carbon-aluminum oxides (NCA), nickel-manganese-carbon (NMC), lithium iron phosphate (LiFePO₄) and lithium manganese oxide (LMO), which may be mixed with another cathode chemistry to provide more specific power if the application requires Li metal batteries. The Li ion batteries may include a lithium metal anode that provides high power on demand, Li ion batteries that have a silicon or titanite anode. A battery may also include, without limitation a battery using nickel based chemistries such as nickel cadmium or nickel metal hydride, a battery using lithium polymer technology, lead-based batteries such as without limitation lead acid batteries, metal-air batteries, or any other suitable battery. Persons skilled in the art, upon reviewing the entirety of this disclosure, will be aware of various other devices that may be used as an energy source 104.

Energy source 104 may include a plurality of energy sources, referred to herein as a module or pack of energy sources. Module or pack may include batteries connected in parallel or in series or a plurality of modules connected either in series or in parallel designed to satisfy any energy requirements. Connecting batteries in series may increase a potential of at least an energy source which may provide more power on demand. High potential batteries may require cell matching when high peak load is needed. As more cells are connected in strings, there may be a greater chance of one cell failing, in which case resistance increases in the module, reducing overall power outlet. Voltage of the module also may decrease as a result of that failing cell. Connecting batteries in parallel may increase total current capacity by decreasing total resistance, and it also may increase overall amp-hour capacity. Overall energy and power outlets of an energy source may be based on individual battery cell performance, or an extrapolation based on a measurement of at least an electrical parameter. In an embodiment where energy source 104 includes a plurality of battery cells, overall power outlet capacity may depend on electrical parameters of each individual cell. If one cell experiences high self-discharge during demand, power drawn from another cell may be decreased to avoid damage to a weakest cell. An energy source may further include, without limitation, wiring, conduit, housing, cooling system and battery management system. Persons skilled in the art will be aware, after reviewing the entirety of this disclosure, of many different components of an energy source.

Energy source 104 may also include an emergency power unit (EPU) (i.e., auxiliary power unit). An emergency power unit may be an energy source as described herein that is configured to power an essential system for a critical function in an emergency, for instance without limitation, when another energy source has failed, is depleted, or is otherwise unavailable. Illustrative non-limiting essential systems include navigation systems, such as multi-function displays (MFD), global positioning systems (GPS), very high frequency omnidirectional range station (VOR) receivers or directional gyros, and other essential flight components, such as propulsors.

Still referring to FIG. 1, electric aircraft 100 may include a pilot control 270, including without limitation, a hover control, a thrust control, an inceptor stick, a cyclic, and/or a collective control, e.g., a mechanical control of an aircraft that allows a pilot to adjust and/or control the pitch angle of the plurality of actuators 260. For example, and without limitation, collective control may alter and/or adjust the pitch angle of all of the main rotor blades collectively. For example, and without limitation pilot control 270 may include a yoke control, e.g., a mechanical control of an aircraft to control the pitch and/or roll. For example, and without limitation, yoke control may alter and/or adjust the roll angle of aircraft 100 as a function of controlling and/or maneuvering ailerons. In an embodiment, pilot control 270 may include one or more footbrakes, control sticks, pedals, throttle levels, and the like thereof. In another embodiment, and without limitation, pilot control 270 may be configured to control a principal axis of the aircraft, e.g., an axis in a body representing one three dimensional orientations. For example, and without limitation, principal axis or more yaw, pitch, and/or roll axis. Principal axis may include a yaw axis, e.g., an axis that is directed towards the bottom of the aircraft, perpendicular to the wings. For example, and without limitation, a positive yawing motion may include adjusting and/or shifting the nose of electric aircraft 10 to the right. Principal axis may include a pitch axis, e.g., an axis that is directed towards the right laterally extending wing of the aircraft. For example, and without limitation, a positive pitching motion may include adjusting and/or shifting the nose of electric aircraft 100 upwards. Principal axis may include a roll axis, e.g., an axis that is directed longitudinally towards the nose of the aircraft, parallel to the fuselage. For example, and without limitation, a positive rolling motion may include lifting the left and lowering the right wing concurrently.

Pilot control 270 may also be configured to modify a variable pitch angle. For example, and without limitation, pilot control 270 may adjust one or more angles of attack of a propeller, e.g., an angle between the chord of the propeller and the relative wind. Additionally, or alternatively, pilot control 270 may be configured to translate a pilot desired torque for flight component, e.g., propulsor 106.

Electric aircraft 100 may also optionally include a loading system. A loading system may include a system configured to load the aircraft of either cargo or personnel. For instance, some illustrative loading systems may include a swing nose, which is configured to swing the nose of electric aircraft 100 of the way thereby allowing direct access to a cargo bay located behind the nose. A notable exemplary swing nose aircraft is Boeing 747.

Still referring to FIG. 1, electric aircraft 100 may include any number of sensors (not shown). The sensors may include any sensor not already described in this disclosure. The sensors may be configured to sense, for example, a characteristic of pilot control 270. The sensors may be a device, module, and/or subsystem, utilizing any hardware, software, and/or any combination thereof to sense a characteristic and/or changes thereof, in an instant environment, for instance without limitation pilot control 270, which the sensor is proximal to or otherwise in a sensed communication with, and transmit information associated with the characteristic, for instance without limitation, as digitized data. In some cases, the sensors may sense a characteristic as an analog measurement, for instance, yielding a continuously variable electrical potential indicative of the sensed characteristic. In these cases, the sensors may additionally comprise an analog to digital converter (ADC) as well as any additional circuitry, such as without limitation a Wheatstone bridge, an amplifier, a filter, and the like. The sensors may be mechanically and/or communicatively coupled to electric aircraft 100, including, for instance, to at least a pilot control 270.

The sensors may be configured to sense any desired characteristic. Non-limiting examples of a sensor may include an inertial measurement unit (IMU), an accelerometer, a gyroscope, a proximity sensor, a pressure sensor, a light sensor, a pitot tube, an air speed sensor, rotational encoder, strain gage, a position sensor, a speed sensor, a switch, a thermometer, a strain gauge, an acoustic sensor, and an electrical sensor. Environmental sensors may detect, without limitation, one or more of: ambient temperature, barometric pressure, air velocity, humidity, oxygen, or the like. Motion sensors may include, without limitation, gyroscopes, accelerometers, inertial measurement unit (IMU), and/or magnetic sensors. Additionally, or alternatively, sensors may include at least a geospatial sensor. Sensors may further include one or more proximity sensors, displacement sensors, vibration sensors, and the like. Sensors may be used to monitor the status of electric aircraft 100 for both critical and non-critical functions. Sensors may be located inside electric aircraft 100, and/or be included in and/or attached to at least a portion of the aircraft, as described herein. Sensors may be incorporated into electric aircraft 100 or be remote.

Electric aircraft 100 may also include a motor 280, which may be mounted on a structural feature of the aircraft, and power various actuators 260, e.g., propulsors 106, using any variety of power transmission.

A number of aerodynamic forces may act upon electric aircraft 100 during flight. Forces acting on electric aircraft 100 during flight may include, without limitation, thrust, the forward force produced by the rotating element of the electric aircraft 100 and acts parallel to the longitudinal axis. Another force acting upon electric aircraft 100 may be, without limitation, drag, which may be defined as a rearward retarding force which is caused by disruption of airflow by any protruding surface of the electric aircraft 100 such as, without limitation, the wing, rotor, and fuselage 110. Drag may oppose thrust and acts rearward parallel to the relative wind. A further force acting upon electric aircraft 100 may include weight, which may include a combined load of the electric aircraft 100 itself, crew, baggage, and/or fuel. Weight may pull electric aircraft 100 downward due to the force of gravity. An additional force acting on electric aircraft 100 may include lift, which may act to oppose the downward force of weight and may be produced by the dynamic effect of air acting on the airfoil and/or downward thrust from propulsor(s) 106 of electric aircraft 100. Lift generated by the airfoil may depend on speed of airflow, density of air, total area of an airfoil and/or segment thereof, and/or an angle of attack between air and the airfoil. For example, electric aircraft 100 are designed to be as lightweight as possible. Reducing the weight of the aircraft and designing to reduce the number of components is essential to optimize the weight. To save energy, it may be useful to reduce weight of components of electric aircraft 100, including without limitation propulsors 106 and/or other propulsion assemblies. In an embodiment, motor 280 may eliminate need for many external structural features that otherwise might be needed to join one component to another component. Motor 280 may also increase energy efficiency by enabling a lower physical propulsor profile, reducing drag and/or wind resistance. This may also increase durability by lessening the extent to which drag and/or wind resistance add to forces acting on electric aircraft 100 and/or propulsors.

Structural features of electric aircraft 100, other than described elsewhere herein, may be constructed of any suitable material or combination of materials, including without limitation metal such as aluminum, titanium, steel, or the like, polymer materials or composites, fiberglass, carbon fiber, wood, or any other suitable material. As a non-limiting example, a structural feature may be constructed from additively manufactured polymer material with a carbon fiber exterior; aluminum parts or other elements may be enclosed for structural strength, or for purposes of supporting, for instance, vibration, torque, or shear stresses imposed by actuator(s) 260. Persons skilled in the art, upon reviewing the entirety of this disclosure, will be aware of various materials, combinations of materials, and/or constructions techniques.

Embodiments of the disclosure provide various technical and commercial advantages, examples of which are discussed herein. As noted, the breakaway port provides un-impinged flow of thermal conditioning liquid, e.g., a coolant, from the port to the electric aircraft. Embodiments of the disclosure enable breakaway for atypical load cases, e.g., aircraft departing with the handle still attached, or operators falling on the mechanism. The breakaway port also provides breakaway of the handle from overload on the handle, among other locations, and not just breakaway for the liquid conduits. The handle can be a location of predetermined force that can create accidental damage, such as an operator falling on the handle. The breakaway port thus prevents any accidental damage to the electric aircraft, thermal conditioning system and/or surrounding equipment in response to load over the predetermined force.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate+/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. A breakaway port for a thermal conditioning system for an electric aircraft, the breakaway port comprising:
a mounting member including at least one port for a thermal conditioning liquid, the at least one port configured to fluidly communicate with a liquid-based thermal conditioning circuit in the electric aircraft;
a breakaway member;
at least one fitting coupled to the breakaway member and configured to liquidly couple to at least one of a thermal conditioning liquid inlet conduit and a thermal conditioning liquid outlet conduit; and
at least one breakaway retainer coupling the breakaway member to the mounting member, the at least one breakaway retainer configured to separate to decouple the breakaway member from the mounting member in response to a predetermined force being applied to the at least one breakaway retainer.

2. The breakaway port of claim 1, further comprising a sealing member between the mounting member and the breakaway member, the sealing member configured to seal between the at least one port and the at least one fitting.

3. The breakaway port of claim 1, wherein the mounting member is configured to be mounted to the electric aircraft.

4. The breakaway port of claim 1, further comprising a connection member extending from the breakaway member, the connection member including a connection element configured to selectively connect to a locking system of a handle to secure the handle to the electric aircraft, wherein the handle couples the thermal conditioning liquid inlet conduit and the thermal conditioning liquid outlet conduit together.

5. The breakaway port of claim 4, wherein the at least one fitting includes an inlet fitting coupled to the thermal conditioning liquid inlet conduit and an outlet fitting coupled to the thermal conditioning liquid outlet conduit, and wherein the inlet fitting, the outlet fitting and the breakaway member decouple as a unit from the mounting member in response to the predetermined force being applied to the at least one breakaway retainer.

6. The breakaway port of claim 5, wherein the connection member interacts with an alignment feature on the handle to align the thermal conditioning liquid inlet conduit with the inlet fitting and the thermal conditioning liquid outlet conduit with the outlet fitting.

7. The breakaway port of claim 4, wherein the locking system includes a plurality of arms pivotally coupled to a latching member configured to engage the connection element.

8. The breakaway port of claim 1, wherein the at least one fitting includes an inlet fitting and an outlet fitting, wherein the inlet fitting and the outlet fitting are threadedly coupled to the breakaway member.

9. The breakaway port of claim 1, wherein each breakaway retainer includes a threaded fastener, whereby each threaded fastener couples the breakaway member to the mounting member.

10. The breakaway port of claim 1, wherein each breakaway retainer includes a snap retainer configured to couple the breakaway member to the mounting member.

11. The breakaway port of claim 1, wherein each breakaway retainer includes a post extending from the mounting member through a retainer opening in the breakaway member, and a retaining member engaging the post and sized to prevent removal of the post through the retainer opening.

12. The breakaway port of claim 1, further comprising a sensor configured to transmit a signal to the thermal conditioning system to cease transmission of the thermal conditioning liquid to the electric aircraft in response to decoupling of the breakaway member from the mounting member.

13. An electric aircraft, comprising:
a propulsor;
an energy source configured to power the propulsor;
a breakaway port for coupling a thermal conditioning system to the energy source for thermally conditioning the energy source, the breakaway port including:
a mounting member including at least one port for a thermal conditioning liquid, the at least one port configured to fluidly communicate with a liquid-based thermal conditioning circuit in the electric aircraft;
a breakaway member;
at least one fitting coupled to the breakaway member and configured to liquidly couple to at least one of a thermal conditioning liquid inlet conduit and a thermal conditioning liquid outlet conduit;
a sealing member between the mounting member and the breakaway member, the sealing member configured to seal between the at least one port and the at least one fitting; and
at least one breakaway retainer coupling the breakaway member to the mounting member, the at least one breakaway retainer configured to separate to decouple the breakaway member from the mounting member in response to a predetermined force being applied to the at least one breakaway retainer.

14. The electric aircraft of claim 13, wherein the mounting member is configured to be mounted to the electric aircraft.

15. The electric aircraft of claim 13, further comprising a connection member extending from the breakaway member, the connection member including a connection element configured to selectively connect to a locking system of a handle to secure the handle to the electric aircraft, wherein the handle couples the thermal conditioning liquid inlet conduit and the thermal conditioning liquid outlet conduit together.

16. The electric aircraft of claim 15, wherein the locking system includes a plurality of arms pivotally coupled to a latching member configured to engage the connection element.

17. The electric aircraft of claim 15, wherein the at least one fitting includes an inlet fitting coupled to the thermal conditioning liquid inlet conduit and an outlet fitting coupled to the thermal conditioning liquid outlet conduit, and wherein the inlet fitting, the outlet fitting and the breakaway member decouple as a unit from the mounting member in response to the predetermined force being applied to the at least one breakaway retainer.

18. The electric aircraft of claim 15, wherein the connection member interacts with an alignment feature on the handle to align the thermal conditioning liquid inlet conduit with the inlet fitting and the thermal conditioning liquid outlet conduit with the outlet fitting.

19. The electric aircraft of claim 13, wherein each breakaway retainer includes a threaded fastener, whereby each threaded fastener couples the breakaway member to the mounting member.

20. The electric aircraft of claim 13, wherein each breakaway retainer includes a snap retainer configured to couple the breakaway member to the mounting member.

21. The electric aircraft of claim 13, wherein each breakaway retainer includes a post extending from the mounting member through a retainer opening in the breakaway member, and a retaining member engaging the post and sized to prevent removal of the post through the retainer opening.

22. The electric aircraft of claim 13, further comprising a sensor configured to transmit a signal to the thermal conditioning system to cease transmission of the thermal conditioning liquid to the electric aircraft in response to decoupling of the breakaway member from the mounting member.
